(19) United States
(12) Patent Application Publication
(10) Pub. No.: US 2012/0208018 A1
(43) Pub. Date: Aug. 16, 2012

(54) WATER-BASED NON-SILICONE ADHESIVE TAPE FOR SKIS

(75) Inventor: Adalbert E. Lavature, Huntington, MA (US)

(73) Assignee: Berry Plastics Corporation, Evansville, IN (US)

(21) Appl. No.: 13/500,964

(22) PCT Filed: Oct. 7, 2010
(86) PCT No.: PCT/US10/51826

§ 371 Date: Apr. 9, 2012

Related U.S. Application Data
(60) Provisional application No. 61/250,333, filed on Oct. 9, 2009.

(51) Int. Cl. C09J 7/02; C09J 133/00; B05D 5/10

(52) U.S. Cl. 428/355 RA; 427/208.4; 524/515; 428/355 AC

(57) ABSTRACT

A silicone-free adhesive composition for use as a tape on skis comprises at least one water-based acrylic polymer pressure sensitive adhesive.

PRIORITY CLAIM

This application claims priority under 35 U.S.C. §119(e) to co-pending U.S. Provisional Application Ser. No. 61/250,333, filed Oct. 9, 2009, which is expressly incorporated by reference herein.

### BACKGROUND

The present disclosure relates to an adhesive composition and an adhesive tape made therewith which may be used during the manufacturing of skis. The tape may be placed on the top of skis and the graphics thereon for the purpose of protecting the graphics during subsequent manufacturing steps. The present disclosure also relates to a method of forming an adhesive tape.

Current formulations for adhesive tapes used for protection of skis during manufacture contain silicone polymers. It would be desirable to have an adhesive tape formulation that was silicone-free and which could protect ski tops during manufacture at high temperatures and pressures, yet would remove cleanly at the end of the ski manufacturing process. Since the current cost of silicone polymer material is increasing, such a tape formulation would reduce the overall cost to manufacture.

Prior efforts to develop a silicone-free product at lower cost have not met with satisfactory commercial success. One effort has developed a water-based cross-linked rubber PSA (pressure sensitive adhesive) tape on similar substrates that do function at lower temperatures (e.g., below 300° F. (149° C.)), but effort has not been able to produce effectively a low cost high temperature product.

### SUMMARY

The present disclosure provides, in one exemplary embodiment, an adhesive tape formulation containing essentially no silicone polymers which is functional across the entire ski manufacture process. The tape of the present disclosure can be produced in different thicknesses and can replace conventional silicone-based adhesive tapes. The tape of the present disclosure can provide properties that are at least comparable to conventional silicone-containing tapes and can function in both low and high temperature manufacturing processes.

The present disclosure provides, in one exemplary embodiment, an adhesive tape composition comprising a blend of a water-based acrylic polymer PSA, a solvent, a high temperature acrylic polymer PSA, high temperature fillers and silane which will perform adequately under similar temperature and pressure conditions as conventional silicone-based adhesive tapes and remove cleanly when desired, yet at an overall reduced cost compared to silicone polymer-based adhesive tapes. The adhesive tape of the present disclosure also is easier to unwind from a roll compared to other tapes used in similar circumstances and for similar applications. The new adhesive construction eliminates or substantially reduces the silicone hidden “ghost” residue left on the surface of the ski top by silicone polymer adhesives. This residue prevents secondary operations to the ski top once the tape has been removed.

In one exemplary embodiment, the present disclosure provides an adhesive formulation for use as a tape on skis, comprising 40-90 wt % of at least one water-based acrylic polymer pressure sensitive adhesive (“PSA”); 5-20 wt % of at least one solvent-based acrylic polymer PSA; 0.25-5 wt % silica; 0.01-2 wt % silane; and, 0.01-3 wt % of at least one isocyanate catalyst.

In one exemplary embodiment, the present disclosure provides a method for producing an adhesive formulation for use as a tape on skis, comprising providing the following components
40-90 wt % of at least one water-based acrylic polymer pressure sensitive adhesive (“PSA”),
5-20 wt % of at least one solvent-based acrylic polymer PSA,
0.25-5 wt % silica,
0.01-2 wt % silane, and,
0.01-3 wt % of at least one isocyanate catalyst;
   mixing the components to produce an adhesive; and, applying the adhesive to a film to produce an adhesive tape.

### DETAILED DESCRIPTION

In one exemplary embodiment the present disclosure provides an adhesive tape formulation comprising at least one water-based acrylic polymer PSA, at least one solvent-based acrylic polymer PSA, colloidal silica, silane, at least one catalyst and, optionally, other solvents. The choice of a water-based acrylic polymer PSA is primarily to lower cost. The water-based acrylic polymer PSA may be used in a range of about 40-90% (all percentages are weight % unless otherwise stated) of the formulation. It is contemplated that a mixture of several different water-based acrylic polymers may be used. Similarly, it is contemplated that a mixture of several different solvent-based acrylic polymers may be used.

The colloidal silica component is a filler and temperature resistance properties. Colloidal silica (also known as pyrogenic silica) may be used in a range of about 0.25-5% of the formulation.

The silane component can help as an intermediary between the solvent acrylic and the water base acrylic may increase bond strength and temperature resistance and may also help keep the adhesive bonded to the film under extreme conditions. Silane may be present in a range of about 0.01-2% of the formulation.

The catalyst component is used for the water-based acrylic polymer PSA portion of the formulation and can act on both the water-based acrylic polymer PSA and the solvent base functional groups. The catalyst can be hydroxyl or carboxyl in functionality. The catalyst may also react with the solvents in the system. For example, isocyanate will react with an alcohol. One or more different catalysts may be used. Depending on the type of catalyst the range may be about 0.01-3% to increase the crosslink density of the water-based acrylic polymer and yield a higher temperature profile. This may also reduce the adhesion and tack properties. The solvent-based acrylic polymer PSA was chosen because it can be modified for high temperature and can improve unwind of the finished tape roll. The solvent-based acrylic polymer PSA adds the remainder of the high temperature properties, and clean removal with no or little ghost. The solvent-based acrylic polymer PSA additive may be present in a range of about 5-20% of the formulation. The formulation in this exemplary embodiment is substantially free of silicone adhesive.

The use of acrylic polymers allows for the easier and more desirable roll unwind. The composition of the present disclosure functions at both high temperature and pressure ranges (e.g., 340° F. (171° C.), 250 PSI for about 4 minutes), yet will remove cleanly while it is still hot or at room temperature. Polypropylene film substrate typically melts during the high temperature process, which would cause the adhesive to separate from the film substrate. The adhesive of the present disclosure is designed to remain with the film even at the film melt point and possibly beyond.

The adhesive tape formulation of the present disclosure can be used to reduce the cost of solvent acrylics, thus allowing parallel lower cost products to be sold. The adhesive tape formulation of the present disclosure can be used with many rubber elastomers, silicone polymers, butyl rubber PSAs and the like. In each case water-based elastomers or polymers may act as the base for its related technology; however, this does not preclude the blending of these materials and other technologies, such as, but not limited to, urethane resins and polymers. In some cases epoxy compounds may be used. As a non-limiting example, this formulation may be blended with an epoxy to obtain higher temperature or to obtain a new bonding characteristic. The new product may be used to protect an epoxy film or product. A variety of tackifiers may be used as are known to those skilled in the art. As a non-limiting example, a thermal setting tackifier may be used which may allow for easer removal of the tape at the end of the process. Alternatively, a tackifier may be used that may allow better bonding to low energy surfaces. Other materials or modifiers may be incorporated, such as, but not limited to, fillers, fumes silicas, clays, metal fillers (e.g., copper, brass, aluminum, iron, mixtures thereof and the like), pigments, catalysts, antioxidants, UV filters, UV absorbers, free radical scavengers and combinations of the foregoing and the like. Flame retardants, such as, but not limited to, halogen and non-halogen flame retardants, may be incorporated. The adhesive tape formulation may also include hydrophobic, oil-phobic, or stain-resistant materials, or combinations of the foregoing. The formulation may also contain release or self-priming agents which are water-based, solvent-based or both. The formulation may also contain aerobic or anaerobic materials, which may increase the adhesive's ability to bond at higher strength under special conditions. Antifungal and mold-resistant materials may also be included, which may be used in environments where mold could be a threat. The formulation may contain materials to prevent freezing or to protect the polymer or elastomer during freezing or high heat. In one exemplary formulation additives may be used to increase the adhesive stability at high temperatures and pressure. For use in cold temperature environments materials may be added to the formulation that may allow for cold temperature bonding. The adhesive formulations of the present disclosure may be used with multiple substrates, polyester, polypropylene, polyimide films, polyamide films, nylon, PVC film cloth, cotton, stretch fabrics, combinations and blends of the foregoing and the like. Papers may be used, such as Nomex high temperature papers and other suitable design papers.

The adhesive may be suitable for multiple layers of film and adhesive that be laminated or otherwise attached to each other for a multiple layer tape. The adhesive is self-wound, i.e., no release liner is required. The adhesive may be coated on both sides of the film to make a double-sided tape or used as a transfer adhesive, both supported or unsupported, on a variety of release liners.

In one exemplary embodiment, desirable properties of the tape include, but are not limited to: being able to perform at temperatures from about 50-170° C. for at least 4 minutes at about 5-10 bars of pressure. The tape should bond to nylon (e.g., #10 and #12 nylon) in both smooth and embossed configurations. The tape should also function on a polyester laminate. Adhesion levels may be 4-6.2 Newtons/25 mm for smooth surfaces and 8-9 Newtons/25 mm for embossed surfaces. The tape should also survive flame etching on the back side of the ski. The adhesive of the present disclosure can also be unwound from a roll more easily than a silicone-based adhesive tape.

The following examples are set forth for purposes of illustration only. Percentages appearing in such examples are by weight unless otherwise stipulated.

### EXAMPLES

### Example 1

One exemplary formulation of an adhesive comprises least one water-based acrylic polymer PSA (40-90%), at least one solvent-based acrylic polymer PSA (5-20%), colloidal silica (0.25-5%), silane (0.01-2%), and isocyanate catalyst (0.01-3%).

### Example 2

One exemplary method of forming a tape comprises a first step of providing least one water base PSA acrylic (5-20%), at least one solvent base acrylic (40-90%), colloidal silica (0.25-5%), silane (0.01-2%), and isocyanate catalyst (0.01-3%). A second step is combining these components so as to create an adhesive composition.

### Example 3

A batch of material was formulated which included the following components shown in Table 3.1:

TABLE 3.1

| F-74 | | |
|---|---|---|
| Add (wt. | | Mix |
| in (lbs.) | Component | (minutes) |
| 12.00 | Water-based acrylic polymer PSA (ROBOND ™ | — |
| | PROHESION ™ 3300, Dow/Rohm & Haas) | |
| 0.960 | Isopropyl alcohol | 5 |
| 0.024 | Silane A/187 | 5 |
| 0.240 | Methyl ethyl ketone | 2 |
| 0.168 | TRITON ® GR5M surfactant | 2 |
| 0.120 | RM-8W Acrysol thickener | 2 |
| 1.090 | LUDOX ™ HS-40 colloidal silica | 5 |
| 0.110 | 4110 solvent-based acrylic polymer PSA | 5 |
| | (Ashland Adhesive Systems) | |
| 0.576 | Cat 320 isocyanate catalyst | 10 |

This formulation may be optimally used for embossed material.

### Example 4

A batch of material was formulated which included the following components (only the solvent-based polymer PSA component amount was changed from Example 3, and the coating thickness was changed) shown in Table 4.1:

TABLE 4.1

| F-70 | | |
|---|---|---|
| Add (wt. | | Mix |
| in (lbs.) | Component | (minutes) |
| 12.00 | Water-based acrylic polymer PSA (ROBOND ™ | — |
| | PROHESION ™ 3300, Dow/Rohm & Haas) | |
| 0.960 | Isopropyl alcohol | 5 |
| 0.024 | Silane A/187 | 5 |
| 0.240 | Methyl ethyl ketone | 2 |
| 0.168 | TRITON ® GR5M surfactant | 2 |
| 0.120 | RM-8W Acrysol thickener | 2 |
| 1.090 | LUDOX ™ HS-40 colloidal silica | 5 |
| 0.072 | 4110 solvent-based acrylic polymer PSA | 5 |
| | (Ashland Adhesive Systems) | |
| 0.576 | Cat 320 isocyanate catalyst | 10 |

This formulation may be optimally used for smooth material.

### Example 5

Any of the preceding formulations may be applied to a film material to produce an adhesive tape. The tape may be stored in strips, sheets, rolls, or the like.

### Example 6

The formulations of Examples 4 and 5 were tested and found to possess properties within the boundaries of being able to:

(a) perform at temperatures from about 50-170° C. for at least 4 minutes at about 5-10 bars of pressure,

(b) bond to nylon (e.g., #10 and #12 nylon) in both smooth and embossed configurations,

(c) function on a polyester laminate,

(d) have adhesion levels in a range of 4-6.2 Newtons25 mm for smooth surfaces and 8-9 Newtons/25 mm for embossed surfaces, and

(e) survive flame etching on the back side of the ski.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

1. An adhesive formulation for use as a tape on skis, comprising:
a) 40-90 wt % of at least one water-based acrylic polymer pressure sensitive adhesive (“PSA”);
b) 5-20 wt % of at least one solvent-based acrylic polymer PSA;
c) 0.25-5 wt % silica;
d) 0.01-2 wt % silane; and,
e) 0.01-3 wt % of at least one isocyanate catalyst.

2. The adhesive formulation of claim 1, wherein the formulation
performs at temperatures from about 50-170° C. for at least 4 minutes at about 5-10 bars of pressure,
can bond to nylon in both smooth and embossed configurations,
functions on a polyester laminate,
has adhesion levels in a range of 4-6.2 Newtons/25 mm for smooth surfaces and in a range of 8-9 Newtons/25 mm for embossed surfaces, and
survives flame etching on the back side of a ski.

3. A method for producing an adhesive tape for use on skis, comprising:
a) providing
40-90 wt % of at least one water-based acrylic polymer pressure sensitive adhesive (“PSA”),
5-20 wt % of at least one solvent-based acrylic polymer PSA,
0.25-5 wt % silica,
0.01-2 wt % silane, and,
0.01-3 wt % of at least one isocyanate catalyst;
b) mixing the components of step a) to produce an adhesive composition; and,
c) applying the adhesive to a film to produce an adhesive tape.

4. The adhesive formulation of claim 1, wherein the formulation is essentially silicone-free.

5. The adhesive formulation of claim 1, wherein the adhesive tape formed with the adhesive formulation is easily removable from and leaves no residue on a substrate to which it is applied.

6. An adhesive tape, comprising:
a) 40-90 wt % of at least one water-based acrylic polymer pressure sensitive adhesive (“PSA”);
b) 5-20 wt % of at least one solvent-based acrylic polymer PSA;
c) 0.25-5 wt % silica;
d) 0.01-2 wt % silane; and,
e) 0.01-3 wt % of at least one isocyanate catalyst,
wherein the tape is manufactured as a roll that can be unwound by hand without a release liner.

7. The adhesive tape of claim 6, wherein the adhesive tape is essentially silicone-free.

8. An adhesive formulation for use as a tape on skis, consisting essentially of:
a) 40-90 wt % of at least one water-based acrylic polymer pressure sensitive adhesive (“PSA”);
b) 5-20 wt % of at least one solvent-based acrylic polymer PSA;
c) 0.25-5 wt % silica;
d) 0.01-2 wt % silane; and,
e) 0.01-3 wt % of at least one isocyanate catalyst.

9. The adhesive formulation of claim 8, further comprising a film substrate to which the adhesive formulation is applied, thereby forming an adhesive tape.

10. The adhesive formulation of claim 8, wherein the adhesive tape
can removably adhere to a surface at temperatures from about 50-170° C. for at least 4 minutes at about 5-10 bars of pressure,
can bond to nylon in both smooth and embossed configurations, and,
has adhesion levels in a range of 4-6.2 Newtons/25 mm for smooth surfaces and in a range of 8-9 Newtons/25 mm for embossed surfaces.
